(19) United States
(12) Patent Application Publication
(10) Pub. No.: US 2026/0350155 A1
(43) Pub. Date: Nov. 5, 2026

(54) ENHANCED SCRIPT FILE TYPE IDENTIFICATION USING MACHINE LEARNING

(71) Applicant: Palo Alto Networks, Inc., Santa Clara, CA (US)

(72) Inventors: Tung-Ling Li, Fremont, CA (US); William Redington Hewlett, II, Mountain View, CA (US); Dongrui Zeng, San Jose, CA (US); Yang Ji, San Jose, CA (US); Wenjun Hu, Santa Clara, CA (US)

(21) Appl. No.: 19/199,154

(22) Filed: May 5, 2025

(51) Int. Cl. G06F 21/55; G06F 16/334; G06F 16/35; G06F 21/56; G06F 21/57

(52) U.S. Cl. CPC G06F 21/554; G06F 16/3347; G06F 16/35; G06F 21/563; G06F 21/577

(57) ABSTRACT

Techniques for enhanced script file type identification using machine learning are disclosed herein. In some embodiments, a method for enhanced script file type identification using machine learning includes preprocessing a file to generate line representations of a sampled subset of the file, processing the line representations of the sampled subset of the file using a machine learning (ML) model to generate a weighted line representation for each of the generated line representations of the sampled subset of the file, compressing the weighted line representations using a layer of the ML model, and determining a file type of the file using a classification model on the compressed weighted line representations.

### BACKGROUND OF THE INVENTION

Malicious actors attempt to infiltrate secure systems using a variety of different methods. Malicious actors may send a file to a secure system which includes malicious code. The code may be an interpreted language which can run on the secure system without needing to compile. Malicious actors may attempt to obfuscate the file type. For example, the file may be given a file name which does not reflect the actual contents of the file. Secure systems can deploy pipelines which can determine whether code in a file is malicious, where each pipeline is optimized for a particular coding language. It can be difficult to determine which pipeline a file should be used on given the methods malicious actors use to obfuscate the file's true contents.

### BRIEF DESCRIPTION OF THE DRAWINGS

Various embodiments of the invention are disclosed in the following detailed description and the accompanying drawings.

FIG. 1 is a block diagram of a security system that classifies files in accordance with some embodiments.

FIG. 2 is a block diagram of a system for generating representative prototypes in accordance with some embodiments.

FIG. 3 is a block diagram of a system for classifying a file in accordance with some embodiments.

FIG. 4 is a block diagram of a simple-attention fuse model in accordance with some embodiments.

FIG. 5 is a flow diagram of a process for determining a file type in accordance with some embodiments.

FIG. 6 is a flow diagram of a process to determine whether a file is malicious in accordance with some embodiments.

FIG. 7 is a flow diagram for using an ML model to classify a file in accordance with some embodiments.

FIG. 8 is a flow diagram for generating prototype representations in accordance with some embodiments.

FIG. 9 is a flow diagram for a process which generates a single vector using a simple-attention fuse model in accordance with some embodiments.

FIGS. 10A-B are examples of how a training file may be augmented in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications, and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A firewall generally protects networks from unauthorized access while permitting authorized communications to pass through the firewall. A firewall is typically a device, a set of devices, or software executed on a device that provides a firewall function for network access. For example, a firewall can be integrated into operating systems of devices (e.g., computers, smart phones, or other types of network communication capable devices). A firewall can also be integrated into or executed as software applications on various types of devices or security devices, such as computer servers, gateways, network/routing devices (e.g., network routers), or data appliances (e.g., security appliances or other types of special purpose devices).

Entities (e.g., companies, organizations, governments, etc.) often store large amounts of files on network databases. A file is any collection of data or information that is stored on a computer or other digital storage devices. Entities must deal with files being downloaded to their databases from many different sources. Sometimes a file may be received from a conspicuous source. For example, a large company may have an employee who accidentally opens a file from a phishing email on a company computer.

Malicious actors may disguise malware in files. Malware can be any software or code designed to harm, exploit, or disrupt computers, networks, or devices. Malware may be used often to steal sensitive information, damage systems, disrupt operations, or gain unauthorized access to resources.

One method of delivering malware to an entity's network is using an interpretive language to write a malicious script in a file. Examples of interpretive languages include JavaScript™ (JS), Python™, Powershell™, Shell, Bash, XML, HTML, PERL™, VBS, ASPX, ASP, Batch, JSON, etc. Interpretive languages may be useful for injecting malware, because running an interpretative language script does not require compilation.

In order to protect networks from interpretive script attacks, entities can use security pipelines designed specifically for the script file type. These security pipelines may be used to determine whether the file of the script file type is malicious. For example, any “.py” file may be run through a Python™ security pipeline. This approach can be effective when the name of the script file type accurately reflects its content. However, malicious actors often hide malicious scripts in files with different file names. For example, a malicious actor may design a malicious Python™ script and write the Python™ script in a “.txt” file.

The techniques disclosed herein provide a computationally efficient method to determine the script file type based on the contents of a file. A file is received at a security system. The file is preprocessed to generate line representation of a sampled subset of the file. The line representations of the sampled subset of the file are processed using a machine learning (ML) model to generate a weighted line representation. The weighted line representation is compressed using a layer of the ML model. The file type of the file is determined using a classification model on the compressed weighted line representations of the file.

Using the techniques disclosed herein the file can be provided to the proper security pipeline. The proper security pipeline can use methods tailored to the actual script language in the file to determine whether the file is malicious. The techniques disclosed herein improve the accuracy of detection of malicious script files. The techniques disclosed herein reduce false positive classifications. The techniques disclosed herein improve the accuracy of detecting the file types of files that previously posed challenges, such as those with long headers. Furthermore, the techniques disclosed herein significantly improve efficacy without sacrificing runtime performance. Thus, the techniques disclosed herein may be deployed to detect malicious file types in real time.

In some embodiments, a system, a process, and/or a computer program for enhanced script file type identification using machine learning includes preprocessing a file to generate line representations of a sampled subset of the file; processing the line representations of the sampled subset of the file using a machine learning (ML) model to generate a weighted line representation (e.g., for each of the generated line representations of the sampled subset of the file); compressing the weighted line representation using a layer of the ML model; and determining a file type of the file using a classification model on the compressed weighted line representation.

In some embodiments, the file type includes a script file type.

In some embodiments, the system, the process, and/or the computer program for enhanced script file type identification using machine learning further includes generating a security verdict by processing the file using a security pipeline, wherein the security verdict is malicious or benign, and performing an action in response to a determination that the file is malicious.

In some embodiments, generating a line representation of a sampled subset of the file further comprises extracting a plurality of bytes from one or more lines of the file.

In some embodiments, a classification ML model includes a convolutional layer, a global max layer, a self-attention layer, and a simple-attention fuse model.

In some embodiments, a layer of the ML model is a Kolmogorov-Arnold Network (KAN) layer for compressing the weighted line representation.

In some embodiments, a prototype embedding space is created by vectorizing each file of a plurality of files to generate a plurality of file vectors; reducing dimensions of each of the plurality of file vectors; and generating prototype representations using clustering.

In some embodiments, determining a file type using a classification model on compressed weighted line representations further comprises determining a minimum distance between an output from the ML model and the prototype representations.

In some embodiments, vectorizing each file of the plurality of files is performed using Term Frequency-Inverse Document Frequency (TF-IDF).

In some embodiments, one or more training files that are used to train an ML model are augmented.

In some embodiments, the script file is determined to be a first file type based on a predetermined confidence threshold, and the processor is further configured to: send the script file to a malware detector for the first file type to determine whether the script file is benign or malware, wherein an action is performed based on a malware determination based on a security policy.

These and other example embodiments for enhanced script file type identification using machine learning will be further described below.

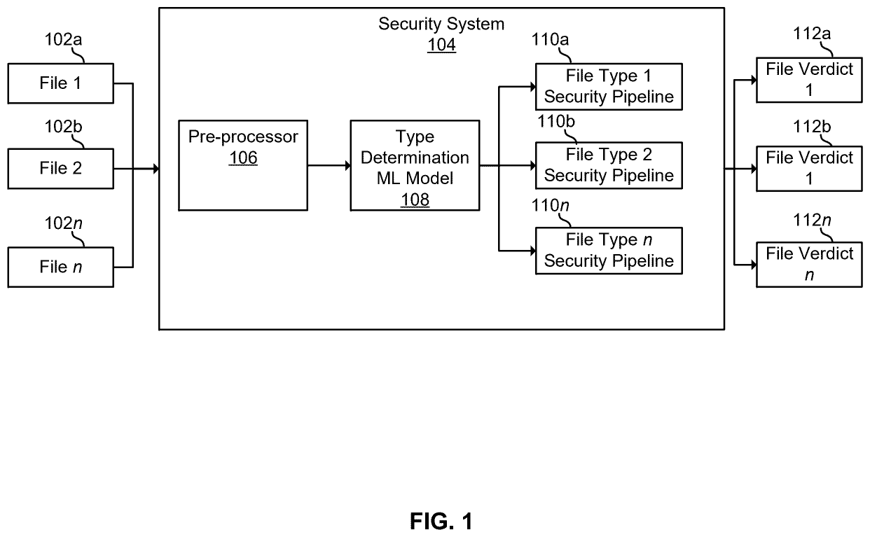

FIG. 1 is a block diagram of a security system that classifies files in accordance with some embodiments. Security system 104 may be deployed on any device. Examples of devices include one or more servers, computers, laptops, phones, tablets, etc. Security system 104 receives files 102a, 102b, . . . 102n and provides corresponding file verdicts 112a, 112b, . . . , 112n. File verdicts 112a:n indicate whether files 102a:n are malicious or benign. In some embodiments, security system 104 is a component of a firewall.

Files 102a, 102b, . . . , 102n are computer files which may be comprised of malicious code. A computer file is any structured collection of bytes. Files 102a:n may have any extension or no extension. Examples of extensions include “.txt”, “.doc”, “.docx”, “.pdf”, “.odt”, “.jpg”, “.jpeg”, “.png”, “.gif”, “.bmp”, “.svg”, “.mp3”, “.wav”, “.flac”, “.aac”, “.mp4”, “.avi”, “.mkv”, “.mov”, “.exe”, “.app”, “.py”, “.html”, “.css”, “.js”, “.java”, “.cpp”, “.c”, “.zip”, “.rar”, “.tar”, “.gz”, “.7z”, etc. In various embodiments, the content of the file is not reflected by the extension of the file. For example, a “.mov” file may include a malicious Python™ script. File 102n may be sent to security system 104 anytime file 102n may end up in a secure network (e.g., an entity database, a device with access to sensitive data, a sensitive server, etc.).

File 102n may comprise data (e.g., bytes) which is only computer readable. Such files can be received and processed by security system 104.

Security system 104 receives a file 102n and returns a verdict representing whether or not file 102n is malicious. Security system 104 may operate in-line within a broader security apparatus such as a firewall. In-line operation includes checking files 102a:n as they are received. Security system 104 comprises pre-processor 106, type determination ML model 108, and file type 1:n security pipelines 110a:n. In some embodiments, pre-processor 106 is the first component which is used on files 102a:n. Pre-processor 106 and ML model 108 determine the file type of a file and send the file to a security pipeline which corresponds to a determined file type.

Security system 104 may be integrated into a cloud-based malware detection platform or a cloud security service to direct script files to appropriate malware analysis systems or services based on the identified file type. These services may include one or more file types 1:n security pipeline 110a:n.

In some embodiments, the script file types identified by the system include at least two or more of the following script file types: Python (.py), JavaScript (.js), PowerShell, Shell, XML, HTML, PERL, VBS, ASPX, ASP, Batch, and JSON, including those with compressed formats or long headers.

In some embodiments, security system 104 determines the script file type to be a first file type based on a predetermined confidence threshold, and wherein security system 104 is further configured to: send the script file to a malware detector for the first file type to determine whether the script file is benign or malware, wherein an action is performed based on a malware determination based on a security policy.

### Pre-Processing

Pre-processor 106 is a component which processes files 102a:n for use on type determination ML model 108. Pre-processing may include generating line representations of a file 102n. Pre-processing may include generating a line representation of a sampled subset of a file 102n. This may comprise extracting a plurality of bytes from one or more lines of the file.

Pre-processor 106 may process file 102n by extracting a subset of data which represents file 102n. In some embodiments, the subset of data is sampled by taking the b number of bytes from l lines of file 102n, where b and l are integers. The l lines of file 102n may be chosen by using a given section file 102n. For example, the l lines may be the first l lines of file 102n.

To illustrate, the sampled subset of data of file 102n may include the first 30 bytes for each of the first 100 lines.

When file 102n comprises a structure with a limited number of lines (e.g., a single line with more than 30 bytes), then the one line may be segmented into b-byte chunks.

When file 102n comprises a structure where two or more lines exceed a number of bytes b, each line may be segmented into b-byte chunks.

When there are fewer than a certain number of lines (e.g., 100 lines), longer lines may be split into chunks to fill out a specified number of b bytes.

When there are more than a certain number of lines, the first b bytes from the first l lines may be used.

A specified number of bytes (e.g., l×b bytes) may be extracted from l lines using b bytes in any conceivable way. Any l lines of the file may be used. Any b bytes of the lines may be used. A long line may be split up to generate l lines. Chunks of b bytes may be extracted from one line.

In some embodiments, a vector with a dimension that is equivalent to the number of lines l is generated.

In some embodiments, type determination ML model 108 receives a particular number of bytes (e.g., 3000-bytes). In these embodiments, pre-processor 106 always generates a subset of a file 102n which is that particular number of bytes. Depending on the structure of a file 102n, this may be done using a variety of procedures. For example, if it is a file with one long line, the line may split in l b-byte chunks where l multiplied by b is equal to the particular number of bytes required by type determination ML model 108.

Pre-processor 106 may execute any other process to prepare files 102a:n for processing by type determination ML model 108. Pre-processor 106 may generate a vector from the subset of the file. For example, type determination ML model 108 is configured to receive a 3000-byte subsection of a file 102n, and pre-processor 106 may generate a 1×100×30 vector of the subset of the file. In this example, the generated vector represents 100 lines with 30-byte chunks.

Pre-processor 106 may improve classification accuracy for script files with long lines by segmenting a line into a predetermined maximum number of bytes to perform extraction across the first maximum number of segments for a maximum number of total bytes sampled from the script file.

Pre-processor 106 may be further configured to ensure that the total input size of a predetermined maximum number of bytes (e.g., 3000 bytes) is maintained by padding or truncating the input vector as needed, optimizing runtime memory usage and latency.

Pre-processor 106 improves classification accuracy for script files with long headers by distributing information extraction across a predetermined maximum number of lines (e.g., the first 100 lines rather than the first 3000 bytes).

### Type Determination ML Model

Type determination ML model 108 is an ML model which receives line representations of files 102a:n and determines the file type of each file 102n. Upon determining the file type, security system 104 can send the file to its proper corresponding file type security pipeline. In some embodiments, type determination ML model 108 generates a file type verdict. Type determination ML model 108 may use an Innocent Until Proven Guilty (IUPG) framework for model training and prediction.

Type determination ML model 108 may comprise a CNN-Transformer model that maintains a lightweight profile (e.g., with a size of approximately 2 MB) and a low classification latency (e.g., of approximately 3 ms), enabling real-time deployment in a cloud-based malware detection system.

### Embedding

In some embodiments, upon receiving a sampled subset of a file 102n from pre-processor 106, type determination ML model 108 generates a numerical representation of the sampled subset. For example, type determination ML model 108 may use an embedding layer on the sampled subset to generate a tensor corresponding to file 102n. For example, a 16-dimensional vector may be produced from a 1×100×30 vector of the file, generating a 1×100×30×16 tensor. In this example, each byte is transformed into a 16-dimensional vector. This tensor may be used on another component of type determination ML model 108.

### Convolutional Layer

In some embodiments, after generating a numerical representation of the sampled subset, the numerical representation is used on a convolutional layer or other similar ML layer (e.g., Vision Transformers, MLP-Mixer Layers, Capsule Networks, Fourier or Spectral Layers, Graph Neural Network (GNN) Layers, etc.).

The convolutional layer may comprise any dimensions (e.g., 1D, 2D, 3D, 4D, etc.) with any number of filters. The dimensions of the convolutional layer may be any number that is less than or equal to the dimensions of the inputs (e.g., the dimensions of the input tensor). The difference between 1D and 2D convolutional layers is the amount of information that is processed at each step.

Filters may comprise small matrices of weights which are used on the numerical representation of the sampled subset through a convolutional operation. This generates a feature space corresponding to the sampled subset. An example configuration of a convolutional layer is a 2D convolutional layer with 256 filters. To further illustrate, a 2D convolutional layer with 256 filters may then extract features along the 30×16 dimension of the 1×100×30×16 tensor.

In some embodiments, a 2D convolutional layer applies 256 filters along the 30×16 dimension of the 1×100×30×16 tensor to extract features, and the global max pooling layer retains the maximum value from each filter's output.

### Global Max Pooling

After using a numerical representation of the sampled subset on the convolutional layer, the resulting vector/tensor may be used on a global max pooling. In some embodiments, each of the extracted features (e.g., from the convolutional layer) are run through the global max pooling layer. Global max pooling is an ML layer which can be used to reduce the spatial dimensions of each feature by taking the maximum value from each one. Global max pooling may include any method which compresses each feature into a single number—its most activated value—resulting in a compact representation of the input from the convolutional layer.

Referring to the example, the output of the convolution layer and the global max pooling layer produce a maximum value for each line in the 1×100×256 line representation.

In this example, the global max pooling layer also generates a 1×100×256 vector, where the dimension of 100 represents the number of lines.

In some embodiments, the filters of the convolutional layer act as multiple sliding windows that will slide through the inputs and calculate a value for each step. This will produce multiple calculated values from each filter. For example, with 256 filters, 256×N values will be produced where N is the number of steps each filter takes to scan the whole input. The global max pooling layer may take the maximum value for each filter. In this example, the global max pooling layer will produce 256×1 values.

In some embodiments, an index embedding vector (e.g., of dimensions 1×100×256) is added to the line representation, where the index embedding vector comprises learned weights representing each line's location.

In some embodiments, an index embedding vector comprises learned weights representing a positional index of each line, ensuring type determination ML model 108 accounts for a sequential structure of the script file.

### Multi-Head Attention/Self-Attention Layer

In some embodiments, the outputs of the global max pooling layer may be used on a multi-head attention/self-attention layer. The multi-head attention/self-attention layer may be any ML layer that performs bidirectional self-attention to enrich line representations with contextual information. The output of the self-attention layer is a vector where one dimension represents the number of lines (e.g., 1×100×256 vector where the dimension of 100 represents the 100 lines of a file).

Self-attention is a mechanism that allows a neural network to weigh the importance of different parts of the input data when making predictions or processing information. In a transformer model, for instance, each token (e.g., a word or a piece of data) attends to every other token in the sequence, computing a weighted representation based on their relationships. This is done using query, key, and value vectors, where the attention scores determine how much focus each token gets relative to others. It is a powerful way to capture dependencies, especially in tasks like natural language processing or image analysis.

In this example, type determination ML model 108 is using the self-attention layer to derive useful information from the relative location of tokens within the files of file 102a:n.

In some embodiments, a multi-head attention layer performs bidirectional self-attention to capture contextual dependencies between lines, enhancing the vector (e.g., 1×100×256 vector) line representation with inter-line relationships.

### Attentional Feature Fusion/Simple-Attention Model

Next, the outputs of the multi-head attention/simple-attention fuse model may be used on an attentional feature fusion/simple-attention fuse model. An attentional feature fusion/simple-attention fuse model aggregates these enhanced line representations into a single vector. An attentional feature fusion/simple-attention fuse model may calculate a score for each line using a fully connected (FC) layer with a single neuron and sigmoid activation. These scores are then used to apply a weight to the corresponding line representations before summation. Referring back to the example, the representation from the attentional feature fusion/simple-attention fuse model will be a 1×256 vector.

In some embodiments, the attentional feature fusion layer calculates a score for each line using a fully connected layer with a single neuron and sigmoid activation, and weights the line representations by scores before summation to produce the vector (e.g., 1×256 vector).

### KAN

Next, the outputs of the attentional feature fusion/simple-attention fuse model may be used on a Kolmogorov-Arnold Network (KAN) layer. The KAN layer processes and compresses this representation into a smaller vector. This compression may be significant. Referring back to the example, the 1×256 vector will be compressed to a 1×32 vector.

KANs are specialized neural networks based on the Kolmogorov-Arnold representation theorem, which asserts that any multivariate continuous function can be decomposed into a finite sum of continuous, univariate functions. In contrast with multilayer perceptrons (MLPs), KANs have learned activation functions as weights on network edges rather than linear weights or activation functions on nodes of the network. KANs have been presented as an alternative to traditional MLPs that can achieve efficient computation and greater interpretability with smaller architectures.

Various other ML layers may be used to compress the weighted line representations. Examples include dense layer, autoencoder bottleneck layer, variational autoencoder (VAE) latent layer, principal component analysis (PCA) layer, embedding layer, transformer encoder bottleneck, convolutional layer with pooling, recurrent neural network (RNN) hidden state, LSTM/GRU hidden state, etc.

### IUPG Framework

Type determination ML model 108 may use an Innocent Until Proven Guilty (IUPG) framework for model training and prediction. In some embodiments, the IUPG approach uses Term Frequency-Inverse Document Frequency (TF-IDF), Uniform Manifold Approximation and Projection (UMAP), and Hierarchical Density-Based Spatial Clustering of Applications with Noise (HDBSCAN) to cluster samples and identify representative samples (cluster centers) for each file type, which are then used to construct prototypes prior to training. Prototypes are defined as learnable weights applied to a linear combination of these representative samples, effectively creating a basis set in the embedding space.

The training data may comprise a plurality of files for each file type. The TF-IDF, UMAP, and HDBSCAN cluster process may produce any number of representative prototypes for each file type using the training data. For example, there may be 30 representative prototypes produced for each file type.

File types indicate the type of programming language included in the file. Examples of programming languages that may be included in a file include JavaScript™ (JS), Python™, Powershell™, Shell, Bash, XML, HTML, PERL™, VBS, ASPX, ASP, Batch, JSON, etc.

The IUPG approach may use other methods to generate clusters of representations. Examples include K-means, hierarchical clustering, DBSCAN, mean shift, gaussian mixture models (GMM), spectral clustering, affinity propagation, birch, agglomerative clustering, optics, fuzzy c-means, etc.

Additionally, any vectorization method may be used in place of TF-IDF. Examples include Bag of Words (BoW), Word2Vec, Doc2Vec, FastText, GloVe, Count Vectorizer, Hashing Vectorizer, BERT Embeddings, Sentence Transformers, ELMo Embeddings, Universal Sentence Encoder, etc.

During training, representations of both training samples and prototypes are extracted using the model architecture of type determination ML model 108, which has been described above.

In some embodiments, L1 Euclidean distances are used to train type determination ML model 108 on the prototypes. In some embodiments, a file type score is calculated using the minimum normalized distance to all prototypes by calculating 1−min(tanh(distances)), where distances represents the minimum distance to all prototypes of that file type. Higher scores indicate a greater likelihood of the sample belonging to the corresponding file type. The weights used in any component used in type determination ML model 108 may be optimized such that the distances between the training data and there corresponding file type prototypes are closer.

During training, the scores will lastly be passed to any optimization function to calculate the loss and then update the weights of type determination ML model 108. In some embodiments, an optimization function uses the cross-entropy loss optimization function. However, an optimization function may be any optimization function, e.g., gradient descent, stochastic gradient descent, mini-batch gradient descent, Adam, AdaGrad, RMSprop, Nesterov accelerated gradient, L-BFGS, momentum, AdaDelta, etc.

The L1 Euclidean distance may also be used for classification. For example, the representation of a new file, as produced by a final KAN layer, may have an L1 Euclidean distance calculated between it and all of the file type prototypes. The file type determination will correspond to the file type prototype which is closest to the new file representation.

Other distances may be used. Examples include Manhattan Distance (L1), Minkowski Distance, Cosine Similarity, Hamming Distance, Chebyshev Distance, Jaccard Similarity, Mahalanobis Distance, Bray-Curtis Dissimilarity, Canberra Distance, etc.

After determining the file type of a file 102n, type determination ML model 108 will send the file to its corresponding file type n security pipeline 110n.

File type 1:n security pipeline 110a:n pipelines each use one or more methods to determine whether a file 102n of the corresponding file type is a malicious script file. For example, a file type n security pipeline 110n for Python™ may include a sandbox for running Python™ script files. In some embodiments, file type n security pipeline 110n comprises ML based tools for determining whether a file 102n is a malicious scripting file. Any form of analysis may be used in file type n security pipeline 110n for determining whether a file 102n is malicious or benign.

File type 1:n security pipeline 110a:n produces a file verdict 112n. File verdict 112 includes a verdict for whether a file 102n is malicious. File verdict 112n may include that a file 102n is a malicious file of a certain file type. File verdict 112n may include any other metadata associated with file 102n. File verdict 112n may be used by any downstream system to perform an action on the file (e.g., block the file) or allow the file. In some embodiments, security system 104 performs an action on a file 102n or blocks a file 102n based on file verdict 112n.

In some embodiments, an action is performed based on a malware determination based on a security policy.

Other examples of actions include quarantining the file, deleting the file, blocking access, alerting the user, logging the incident, notifying the administrator, moving to a secure location, renaming the file, isolating the system, starting a malware scan, etc.

File types indicate the type of programming language included in the file. Examples of programming languages that may be included in a file include JavaScript™ (JS), Python™, Powershell™, Shell, Bash, XML, HTML, PERL™, VBS, ASPX, ASP, Batch, JSON, etc.

The IUPG classification module reduces false positives by enhancing robustness to out-of-distribution content, achieving low false positive rates in production environments.

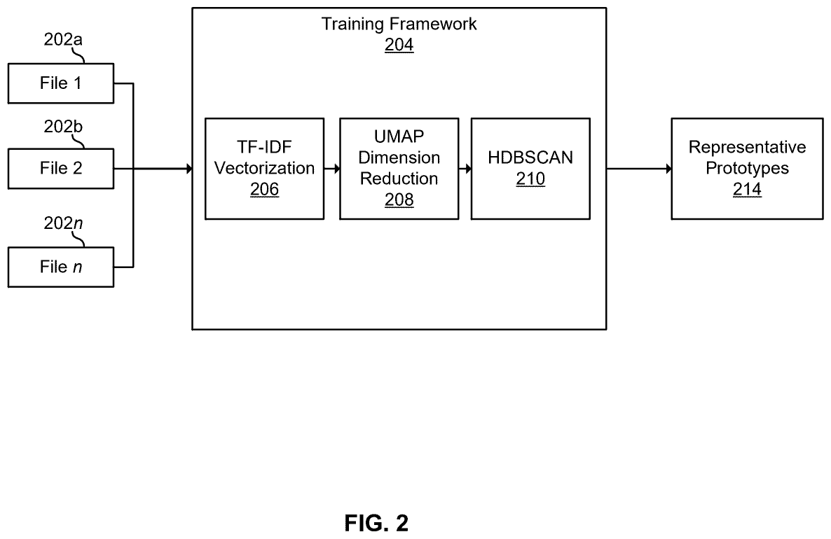

FIG. 2 is a block diagram of a system for generating representative prototypes in accordance with some embodiments. File 202a:n are files with a known file type. Training framework 204 receives files 202a:n and generates representative prototypes 214. Representative prototypes 214 may include representative prototypes associated with many different file types.

Files 202a, 202b, . . . , 202n are computer files with a known file type. For example, file 202a may be known to be a Bash file. A computer file is any structured collection of bytes. Files 202a, 202b, . . . , 202n include files from all file types that can be used as a scripting language. This is done in order to generate a plurality of clusters for all the different file types such that a new file may be compared to the clusters and the file type determined. The data (e.g., the bytes) of files 202a:n are used to generate clusters corresponding to each of the file types represented by the plurality of files.

In some embodiments, a proportion of files 202a:n are malicious (e.g., malicious scripting files) for each file type. For example, there may be 50% malicious Python™ files and 50% benign Python™ files.

In some embodiments, file 202n is augmented such that the training data may be used to improve an ML model's (e.g., type determination ML model 108) robustness against diverse file formats. For example, some training files may be compressed into a single line, where the single line is long. For example, an HTML/JS file may be a single line. Using one or more single line files simulates compressed files which may be encountered in production.

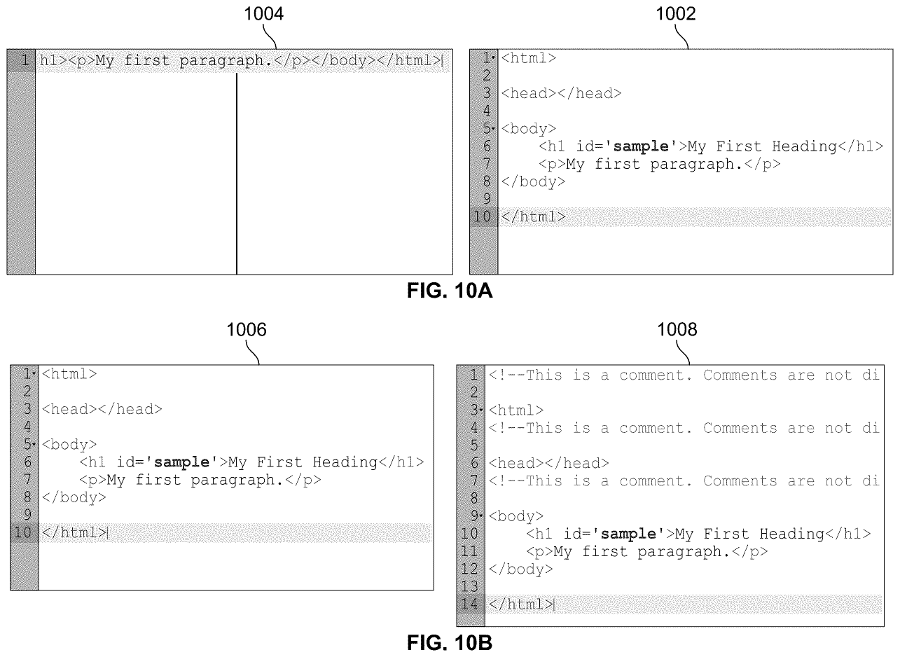

In another augmentation, comments/headers are randomly inserted throughout a file 202n to make an ML model less susceptible to distraction or influence from extraneous comments. Two examples of how a file may be augmented are provided in FIGS. 10A-10B.

Training framework 204 receives files 202a:n and generates representative prototypes 214 using clustering techniques. In some embodiments, when a file 202n is received by training framework 204, it sends the file to TF-IDF (Term Frequency-Inverse Document Frequency) vectorization 206 for vectorization.

TF-IDF vectorization 206 is a component of training framework 204 which vectorizes the data included in a file 202n. TF-IDF is useful for transforming unstructured text into structured numerical data while emphasizing meaningful, distinguishing character sequences. Character sequences may be defined in any logical manner that can be used to define character sequences in files which comprise scripting languages. For example, character sequences can be split up by any token (e.g., white space, lower case characters, N-Grams, etc.).

TF-IDF may be executed by treating each file 202n and/or each portion of a file 202n of a certain file type as a separate item of a corpus. Term Frequency (TF) measures how often a character sequence appears in a file 202n, while Inverse Document Frequency (IDF) downscales character sequences that appear frequently across all files 202n of a file type, highlighting more unique terms. The result is a numerical vector for each file 202n, where each dimension represents a character sequence in the corpus, and the value corresponds to the TF-IDF score.

Using TF-IDF vectorization 206 on a file 202n may result in a vector that is large for each file. This is because the corpus used may comprise a large number of character sequences. This may further result in noisy data with useless character sequences. Thus, it may be desirable to reduce the dimension size of the TF-IDF vector for each file 202n. This may be done using any method to reduce dimension sizes (e.g., Principal Component Analysis (PCA), t-Distributed Stochastic Neighbor Embedding (t-SNE), Singular Value Decomposition (SVD), Autoencoders, Feature selection, Random Projection, Linear Discriminant Analysis (LDA), Isomap, etc.). In this example, Uniform Manifold Approximation and Projection (UMAP) is used to reduce the dimensions of the TF-IDF vector produced for each file 202n.

UMAP dimension reduction 208 is a component of training framework 204 that applies UMAP dimension reduction to a vector produced by TF-IDF. UMAP reduces the dimensions of a vector by modeling the data as a high-dimensional graph and then optimizing a low-dimensional graph to preserve the same structure. It first constructs a neighborhood graph in the original space, capturing the relationships between nearby points. Then, it projects the data into a lower-dimensional space (like 2D or 3D) by minimizing the difference between the high- and low-dimensional graphs.

The resulting dimensions of the vector with reduced dimensions may be variable. For example, the user may define the resulting dimension size. To illustrate a reduction in dimension size, an output vector of TF-IDF vectorization 206 may be 10,000 units in length and UMAP dimension reduction 208 may reduce the vector to a vector that is 150 units in length.

Training framework 204 may use any clustering algorithm to generate clusters for the vectors corresponding to file 202a:n (e.g., vectors output from TF-IDF vectorization 206 and/or UMAP dimension reduction 208). Examples of clustering algorithms include K-Means, Hierarchical Clustering, DBSCAN, HDBSCAN, Mean Shift, Gaussian Mixture Models (GMM), Affinity Propagation, Spectral Clustering, Birch, OPTICS, etc.

In this example, HDBSCAN is used as the clustering algorithm.

HDBSCAN 210 is a component that receives a vector from a previous component and generates clusters corresponding to those vectors. HDBSCAN (Hierarchical Density-Based Spatial Clustering of Applications with Noise) is a clustering algorithm that extends DBSCAN by building a hierarchy of clusters based on varying density levels. It starts by calculating the density of data points and creating a minimum spanning tree of the data based on distance and density. From this, it constructs a hierarchy of clusters and then selects the most stable ones using a measure of cluster persistence. Unlike DBSCAN, HDBSCAN can find clusters of varying densities and handles noise (outliers) more effectively, making it well-suited for complex, real-world data.

HDBSCAN 210 generates clusters which are included in representative prototypes 214. The number of clusters that HDBSCAN 210 generates may be variable. HDBSCAN is an algorithm that will self-detect and generate the optimal number of clusters based on the data distribution. Hence, the number of clusters generated could vary. In some embodiments, when the number of clusters is higher than a maximum number×of representatives, a random×clusters are selected.

Representative prototypes 214 are a plurality of clusters that represent one or more prototypes of one or more file types. Representative prototypes 214 may include separate embedding spaces for each file type. For example, there may be an embedding space of representative prototypes for JavaScript™ prototypes and an embedding space of representative prototypes for Python™ prototypes. In some embodiments, the prototypes are maintained in one embedding space.

In some embodiments, clusters are represented using center points of the cluster. The center point may be calculated by deriving a point that is closest to each of the points in the cluster. Thus, a cluster may be represented by a single point. This single center point can be used for comparison when performing IUPG classification and/or training.

Representative prototypes 214 can be used to train an ML model (e.g., type determination ML model 108) using an IUPG training framework.

To illustrate, suppose files 202a:n are 100,000 JavaScript™ files. TF-IDF vectorization 206 will generate vector representations of each of files 202a:n. UMAP dimension reduction 208 will compress each of theses representations. HDBSCAN 210 will cluster these representations to generate 20 clusters (as an example) which represent prototypical JavaScript™ files. This embedding space with the 20 clusters may be used as representative prototypes 214 specifically for JavaScript™ files. In some embodiments, the 20 clusters are further compressed to 20 center points corresponding to each of the clusters.

To further illustrate, these prototypes may be used to train an ML model. One method would include running 20 clusters through the ML model to generate vector representations of the clusters as they would be generated from the ML model. Now a plurality of JavaScript™ files can be run through the ML model and their representations can be determined and compared to that of the 20 clusters. The goal is to ensure that the ML model is optimally identifying JavaScript™ files as JavaScript™ files. This can be done by optimizing the L1 Euclidean distance of each of the training JavaScript™ files to the 20 clusters. Any optimization function (e.g., cross-loss entropy) may be used to readjust the weights of the ML model to ensure that the files are optimally identified.

In order to train the ML model to identify different file types, the process described above is done for all file types and the ML model must be trained/optimized using files from all file types in a similar manner.

To illustrate, representative prototypes 214 is configured to comprise clusters generated from a plurality of files from different file types (e.g., JavaScript™ (JS), Python™, Powershell™, Shell, Bash, XML, HTML, PERL™, VBS, ASPX, ASP, Batch, JSON, etc.). These clusters are generated using training framework 204 where files 202a:n include a plurality of files from each file type. After this, a plurality of files of each file type may be used on the ML model and the ML model may be optimized to ensure that each file optimally has a minimum distance to the correct cluster (e.g., using a cross-entropy loss function and L1 Euclidean distances).

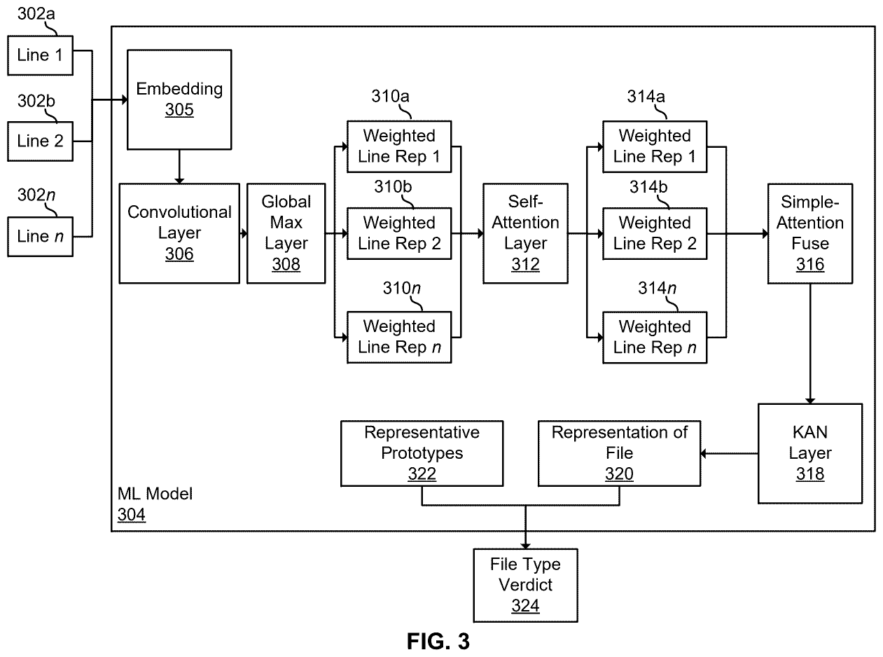

FIG. 3 is a block diagram of a system for classifying a file in accordance with some embodiments. ML model 304 receives lines 302a:n which correspond to a file and generate file type verdict 324 which is associated with the file of lines 302a:n. ML model 304 may be a part or a whole of type determination ML model 108.

Lines 302a, 302b, . . . , 302n correspond to the one or more lines in a file. Lines 302a:n may be generated from a file by a pre-processor, such as pre-processor 106. A sampled subset of data may comprise lines 302a:n. Each line 302n may be a sample of the lines of a file. For example, line 302a may comprise b bytes of the first line of a file. Lines 302a:n may be sampled from any part of the file.

Lines 302a:n may be a sampled subset of a file of Lines 302a:n that may be generated by extracting a plurality of bytes from one or more lines of a file.

Lines 302a:n may be concatenated into a single vector where n is a dimension of the vector. For example, if the number of bytes required by ML model 304 is 3000-bytes, lines 302a:n can be concatenated into a 1×100×30 vector, where n=100 and b=30. Here, n is the number of lines in lines 302a:n and b is the number of bytes extracted from the lines.

ML model 304 receives the lines 302a:n which correspond to a file and returns a file type verdict 324. File type verdict 324 may be used to determine what type of security pipeline the file should be sent through. ML model 304 may be trained using training framework 204.

In some embodiments, lines 302a:n are used on embedding 305 to generate a numerical representation of the lines. Embedding 305 is a component which uses any method to generate numerical representations of lines 302a:n. For example, a 16-dimensional tensor may be produced from a 1×100×30 vector of the file, generating a 1×100×30×16 dimensional tensor. In this example, each byte is transformed into a 16-dimensional vector.

Convolutional layer 306 includes one or more convolutional layers that are used on the numerical representations of lines 302a:n. Convolutional layer 306 may comprise any dimensions (e.g., 2D, 3D, 4D, etc.) and have any number of filters. Dimensions correspond to the dimensions of the inputs of the sampled representations. Filters may comprise small matrices of weights which are used on the numerical representation of embedded lines through a convolutional operation.

This generates a feature space corresponding to the sampled subset. An example configuration of a convolutional layer is a 2D convolutional layer with 256 filters. To further illustrate, a 2D convolutional layer with 256 filters may then extract features along the 30×16 dimension of the 1×100×30×16 tensor.

Global max layer 308 uses a global max pooling method on the outputs of convolutional layer 306 and generates weighted line representations 310a:n. Global max pooling can be used to reduce the spatial dimensions of each feature. The features are generated by the number of filters of convolutional layer 306 (e.g., 256 filters). Global max layer 308 may take the maximum value from each of the features and reduce the dimensions of the features.

Weighted line representations (rep) 310a, 310b, . . . , 310n each correspond to lines 302a, 302b, . . . , 302n after processing by convolutional layer 306 and weighting by global max layer 308. The n of weighted line reps 310a:n is equivalent to the n of lines 302a:n.

Referring to the example, the output of the convolution layer and global max layer 308 results in a 1×100×256 line representation, where n=100 and corresponds to the number of lines 302a:n and the number of weighted line representations 310a:n.

In some embodiments, the filters of convolutional layer 306 act as multiple sliding windows that will slide through the inputs and calculate a value for each step. This will produce multiple calculated values from each filter. For example, with 256 filters, 256×N values will be produced where N is the number of steps each filter takes to scan the whole input. Global max layer 308 may take the maximum value for each filter. In this example, the global max layer 308 will produce 256×1 values.

Weighted line reps 310a:n are used on self-attention layer 312.

Self-attention layer 312 is an ML layer which performs bidirectional self-attention to enrich line representations with contextual information. For example, weighted line rep 310a may be enriched with information which indicates that it comes right before weighted line rep 310b. This may be done using a key, value, and query scheme. The output of the self-attention layer is a vector where one dimension represents the number of lines. This vector is split into weighted line reps 314a:n.

Referring to the example, weighted line reps 314a:n comprise a 1×100×256 vector with values, where n=the dimension of 100. Weighted line reps 314a:n differ because they include the contextual information of where they are located.

Weighted line reps 314a:n are used on simple-attention fuse 316.

Simple-attention fuse 316 includes one or more ML layers which condense weighted line reps 314a:n into a vector with less dimensions. Simple-attention fuse 316 calculates a score for each weighted line reps 314a:n using a fully connected (FC) layer with a single neuron and sigmoid activation. These scores are then used to apply a weight to the corresponding line representations before summation.

Referring to the example, the representation from simple-attention fuse 316 will be a 1×256 vector.

The outputs of simple-attention fuse 316 may be used on a Kolmogorov-Arnold Network (KAN) layer 318.

KAN layer 318 processes and compresses outputs from simple-attention fuse 316 into a smaller vector. This compression may be significant. Referring back to the example, the 1×256 vector may be compressed to a 1×32 vector. The amount of compression depends on the properties of KAN layer 318. The properties for compression may be set by the user or provider of ML model 304. The KAN layer that compresses a vector to a 1×32 vector is defined as a 32 KAN layer.

KAN layer 318 utilizes the Kolmogorov-Arnold representation theorem, which asserts that any multivariate continuous function can be decomposed into a finite sum of continuous, univariate functions. In contrast with multilayer perceptrons (MLPs), KANs have learned activation functions as weights on network edges rather than linear weights or activation functions on nodes of the network.

KAN layer 318 generates representation of file 320.

Representation of file 320 is the output of KAN layer 318 and represents the file which includes lines 302a:n. Representation of file 320 is a numerical vector/tensor. Referring back to the example, representation of file 320 would comprise the 1×32 vector produced by KAN layer 318.

Representation of file 320 is compared to representative prototypes 322 in order to generate file type verdict 324, where file type verdict 324 corresponds to the file which includes lines 302a:n.

Representative prototypes 322 comprise numerical representations of prototypes for one or more different file types. These prototypes may be produced by a training framework such as training framework 204.

In some embodiments, an IUPG framework is used to compare representation of file 320 to representative prototypes 322 in order to generate file type verdict 324. This may be done by employing an L1 Euclidean distance scheme. For example, representation of file 320 may have an L1 Euclidean distance calculated between it and all of the file type prototypes included in representative prototypes 322. File type verdict 324 will correspond to the file type prototype which is closest to the representation of file 320. In some embodiments, a file type score is calculated using the minimum normalized distance to all prototypes by calculating 1−min(tanh(distances)) where distances represents the minimum distance to all prototypes of that file type. Higher scores indicate a greater likelihood of the sample belonging to the corresponding file type.

File type verdict 324 is a file type that has been determined by ML model 304 after analyzing lines 302a:n. File type verdict 324 may be used to determine which file type security pipeline to send the file corresponding to lines 302a:n.

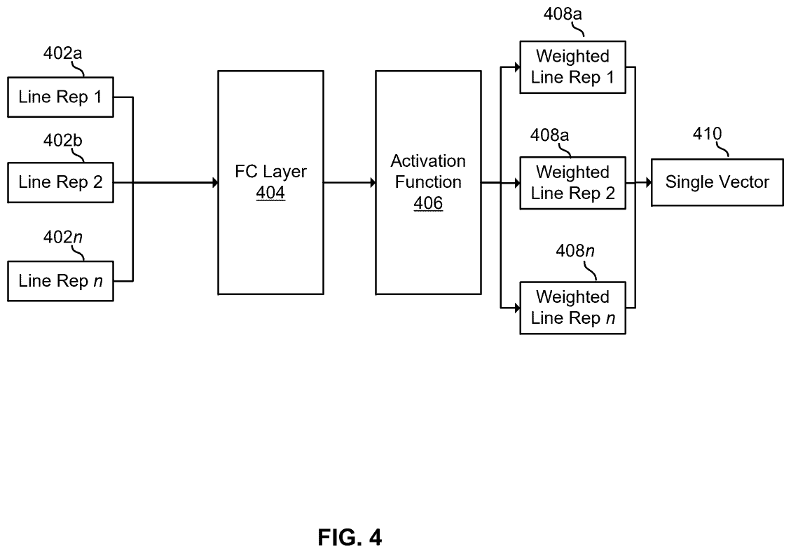

FIG. 4 is a block diagram of a simple-attention fuse model in accordance with some embodiments. Simple-attention fuse 316 may include the components in FIG. 4 in whole or in part. Line reps 402a:n may be generated by a self-attention layer, such as self-attention layer 312. Line reps 402a:n are compressed into single vector 410.

Line reps 402a, 402b, . . . , 402n are numerical representations of lines of characters that are within the same file. In some embodiments, line reps 402a:n have been processed by one or more other ML layers. Line reps 402a:n may be weighted line reps.

Line reps 402a:n are first used on a fully connected (FC) layer 404.

FC layer 404 is any type of ML layer where every neuron in the layer is connected to every output of the previous layer. In some embodiments, FC layer 404 comprises a single neuron, where each of line rep 402a:n is used on the single neuron. FC layer 404 may comprise a scaler that is multiplied by each number in a vector of each line 402n. A sum is taken of the multiplied numbers in a vector of each line 402n and used on activation function 406. In some embodiments, a bias associated with FC layer 404 is included in this calculation.

For example, suppose lines rep 402a:n is a 1×100×256 vector, where n=100 (e.g., represents the number of lines). Then when lines rep 402a:n is passed through FC layer 404, a scaler is multiplied along the dimension with 256 units. Now, each of the 256 units is summed. The sum of each of these 256 units is used on the activation function 406.

Part of the output of the FC layer is used on activation function 406.

Activation function 406 is a mathematical function which is applied to the outputs of FC layer 404 that introduces nonlinearity. In some embodiments, each part of the vector from FC layer 404 that corresponds to each of the line reps 402a:n may be run through activation function 406 in an independent manner. Activation function 406 may be a sigmoid activation function.

Activation function 406 may be any other activation function. Examples include Softmax, ReLu, Tanh, etc.

Activation function 406 receives the sum of the weighted numbers for each line 402n, runs it through an activation function, and generates a score for each line. These scores are then used to apply a weight to the corresponding line representations. This generates weighted line reps 408a:n.

Weighted line reps 408a:n correspond to line reps 402a:n. Each weighted line rep 408n is weighted by the output of activation function 406 for each of line reps 402a:n.

Weighted line reps 408a:n are summed to generate single vector 410.

Single vector 410 is generated by summing each feature dimension through the weighted line reps 408a:n.

Following the example, single vector 410 will have the dimensions of 1×256. In some embodiments, single vector 410 is passed through a KAN layer. The KAN layer may generate a final representation which is compared to representative prototypes in order to generate a file verdict.

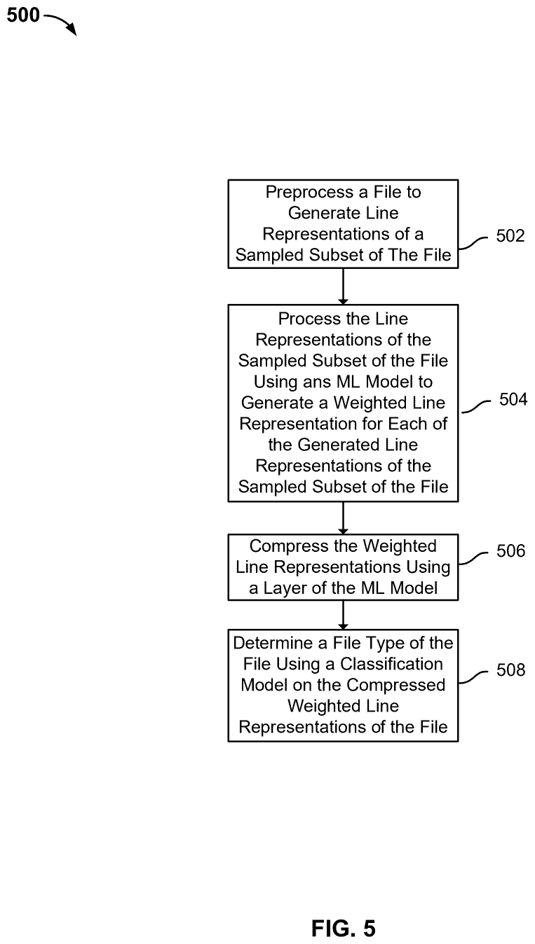

FIG. 5 is a flow diagram of a process for determining a file type in accordance with some embodiments. Process 500 may be executed by a security system such as security system 104. Process 500 may begin after a file is received by a system executing the process.

At 502, a file is preprocessed to generate line representations of a sampled subset of the file. Preprocessing the file includes generating a sampled subset of the file. The sampled subset may be generated by extracting any b bytes from l lines where b and l are integers. The l lines of the file may be chosen by using a given section of the file. For example, the l lines may be the first l lines of the file. When a file comprises a structure with a limited number of lines (e.g., a single line with more than 30 bytes), then the one line may be segmented into b-byte chunks. When the file comprises a structure where two or more lines exceed the number of bytes b, each line may be segmented into b-byte chunks.

Generating a line representation of a sampled subset of the file may comprise extracting a plurality of bytes from one or more lines of the file.

Generating a line representation of the sampled subset of the file includes transforming a part or whole of the sampled subset into a vector of numbers. This may be accomplished using embedding. For example, each of the number of l lines may be run through an embedding layer.

At 504, the line representations of the sampled subset of the file are processed using an ML model to generate a weighted line representation for each of the generated line representations of the sampled subset of the file. This step includes feeding the line representations of step 502 through one or more ML layers. For example, the line representations may first be fed through a convolutional layer, a global max layer, a self-attention layer, and then a simple-attention fuse layer.

In some embodiments, a self-attention layer generates a set of weighted line representations for each of the corresponding generated line representations of step 502. The self-attention layer may send the set of weighted line representations to a simple-attention fuse layer. The simple-attention fuse layer may then use its output for step 506.

The convolutional layer may comprise any dimensions (e.g., 2D, 3D, 4D, etc.) with any number of filters. In some embodiments, another layer similar to a convolutional layer is used (e.g., Vision Transformers, MLP-Mixer Layers, Capsule Networks, Fourier or Spectral Layers, Graph Neural Network (GNN) Layers, etc.).

Global max pooling is an ML layer which can be used to reduce the spatial dimensions of each feature by taking the maximum value from each one. Global max pooling may include any method which compresses each feature into a single number—its most activated value—resulting in a compact representation of the input from the convolutional layer.

In some embodiments, the outputs of the global max pooling layer may be used on a multi-head attention/self-attention layer. The multi-head attention/self-attention layer may be any ML layer that performs bidirectional self-attention to enrich line representations with contextual information.

An attentional feature fusion/simple-attention fuse model aggregates these enhanced line representations into a single vector. An attentional feature fusion/simple-attention may calculate a score for each line using a fully connected (FC) layer with a single neuron and sigmoid activation function. This vector comprises a weighted line representation of the line representations of step 504.

The sigmoid activation function may use other activation functions instead. Examples of other types of activation functions include Softmax, ReLu, Tanh, etc.

At 506, the weighted line representations are compressed using a layer of the ML model. This may be accomplished using a KAN layer. KANs are specialized neural networks based on the Kolmogorov-Arnold representation theorem, which asserts that any multivariate continuous function can be decomposed into a finite sum of continuous, univariate functions. Various other ML layers may be used to compress the weighted line representations. Examples include dense layer, autoencoder bottleneck layer, variational autoencoder (VAE) latent layer, principal component analysis (PCA) layer, embedding layer, transformer encoder bottleneck, convolutional layer with pooling, recurrent neural network (RNN) hidden state, LSTM/GRU hidden state, etc.

At 508, the compressed weighted line representations of the file are used on a classification model to determine its file type. This may be done using any method to compare to vectors. In some embodiments, the vectors are compared using representative prototypes which are generated using any vectorization method and clustering method.

Examples of vectorization methods include TF-IDF, Bag of Words (BoW), Word2Vec, Doc2Vec, FastText, GloVe, Count Vectorizer, etc. Examples of clustering methods include HDBSCAN, K-means, hierarchical clustering, DBSCAN, mean shift, gaussian mixture models (GMM), spectral clustering, etc. The compressed weighted line representations of the files may be compared to representative clusters using any method for comparing vectors in an embedding space. One example is determining which representation is the closest using an L1 Euclidean distance scheme. Other measures may be used such as the Manhattan Distance (L1), Minkowski Distance, Cosine Similarity, Hamming Distance, Chebyshev Distance, Jaccard Similarity, Mahalanobis Distance, Bray-Curtis Dissimilarity, Canberra Distance, etc.

In some embodiments, after determining a file type, a file verdict is generated. The file verdict may be generated by using the file on a particular security pipeline.

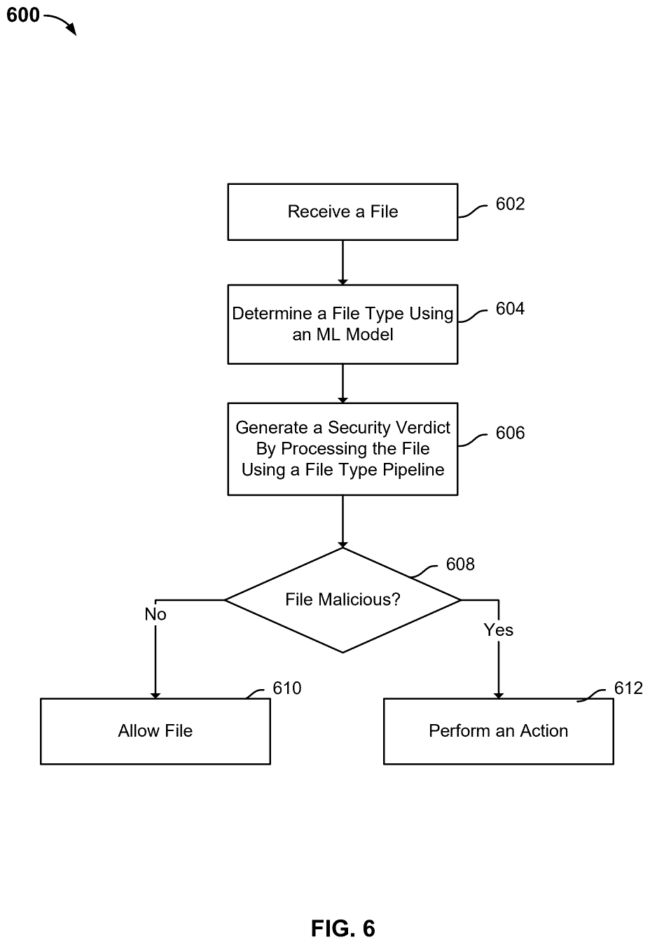

FIG. 6 is a flow diagram of a process to determine whether a file is malicious in accordance with some embodiments. Process 600 may be executed by a security system such as security system 104. Process 600 may be used to determine the type of a scripting file based on its contents and then determine whether the scripting file is malicious.

At 602, a file is received. The file may be received from a variety of sources, for example, any time a file is exposed to a protected network (e.g., a file gets emailed to an employee working on a company computer that is on the company network). The file may have an extension that is does not reflect the actual contents of the file (e.g., a “.txt” file with Python™ code). In some embodiments, the file is a malicious scripting file.

At 604, the file type is determined using a machine learning (ML) model. In some embodiments, the file is pre-processed prior to being used on an ML model. A pre-processor such as pre-processor 106 may be used to pre-process the file. Any ML model may be used to determine the file type. For example, type determination ML model 108 may be used. ML model 304 may also be used.

At 606, a security verdict is generated by processing the file using a file type pipeline. The file type pipeline may be configured to specifically analyze the file of the corresponding file type. Any form of analysis may be used by a file type security pipeline for determining whether the file is malicious or benign. For example, a file type security pipeline for Python™ may include a sandbox for running Python™ script files. The security verdict may indicate that the file is malicious or benign.

At 608, it is determined whether the file is malicious. This may be done using the results produced by the file type pipeline. In response to a determination that the file is malicious process 600 proceeds to step 612. In response to a determination that the file is not malicious, process 600 proceeds to step 610.

At 610, the file is allowed. This may mean allowing the file to be stored on a server, allowing the file to be sent, and/or giving the file any security permissions appropriate for a file that has been deemed benign.

At 612, an action is performed. This may mean flagging the file as malicious, blocking the file from accessing parts of a network, blocking the file at a firewall, and/or any other action appropriate for addressing a malicious file.

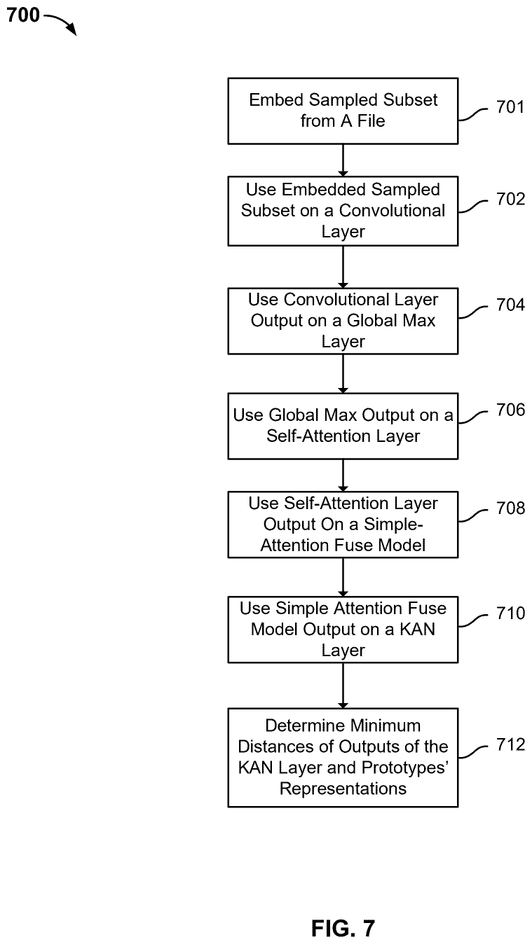

FIG. 7 is a flow diagram for using an ML model to classify a file in accordance with some embodiments. In some embodiments, part or all of step 604 is executed using part or all of process 700. In some embodiments, an ML model executes process 700.

At 701, a sampled subset from a file is embedded. A sampled subset of the file may include any set of bytes from the file. Embedding the sampled subset includes transforming the bytes of the file into a numerical representation.

At 702, the embedded sampled subset is used on a convolutional layer. The convolutional layer may comprise any dimensions (e.g., 2D, 3D, 4D, etc.) with any number of filters. The dimensions of the convolutional layer may be any number that is less than or equal to the dimensions of the inputs (e.g., the dimensions of the input tensor). The difference between 1D and 2D convolutional layer is the amount of information that is processed at each step. Filters may comprise small matrices of weights which are used on the numerical representation of the sampled subset through a convolutional operation. Outputs from the convolutional layer include a vector/tensor.

At 704, the convolutional layer output is used on a global max layer. In some embodiments, each of the extracted features (e.g., from the convolutional layer) are run through the global max pooling layer. Global max pooling is an ML layer which can be used to reduce the spatial dimensions of each feature by taking the maximum value from each one. Global max pooling may include any method which compresses each feature into a single number—its most activated value—resulting in a compact representation of the input from the convolutional layer. The outputs may include a vector/tensor.

At 706, the outputs of the global max layer are used on a self-attention layer. Self-attention is a mechanism that allows a neural network to weigh the importance of differing parts of the input data when making predictions or processing information. In a transformer model, for instance, each token (e.g., a word or a piece of data) attends to every other token in the sequence, computing a weighted representation based on their relationships. The outputs may include a vector/tensor.

At 708, the outputs of the self-attention model are used on a simple-attention fuse model. A simple-attention fuse model may calculate a score for each line representation within the outputs using a fully connected (FC) layer with a single neuron and sigmoid activation function or other type of activation function. Other types of activation functions include Softmax, ReLu, Tanh, etc. These scores are then used to apply a weight to the corresponding line representations before summation. The outputs may include a vector/tensor.

At 710, the outputs of the simple-attention fuse model are used on a KAN layer. The KAN layer processes and compresses this representation into a smaller vector. KANs are specialized neural networks based on the Kolmogorov-Arnold representation theorem, which asserts that any multivariate continuous function can be decomposed into a finite sum of continuous, univariate functions.

At 712, the minimum distances between outputs of the KAN layer and prototypes'representations are determined. The prototype representations may be stored in an embedding space. The minimum distance is determined by calculating one or more distances between the outputs of the KAN layer and one or more prototypes in an embeddings layer. These distances may be calculated using a variety of methods. Examples include L1 Euclidean Distance, Manhattan Distance (L1), Minkowski Distance, Cosine Similarity, Hamming Distance, Chebyshev Distance, Jaccard Similarity, Mahalanobis Distance, Bray-Curtis Dissimilarity, Canberra Distance, etc.

The prototypes'representation's embedding space may be generated using a training framework such as training framework 204. The prototypes may be prototypical of one or more different file types. The minimum distance between the outputs of the KAN layer and one or more prototypes may be used to determine the file type of the file in 701.

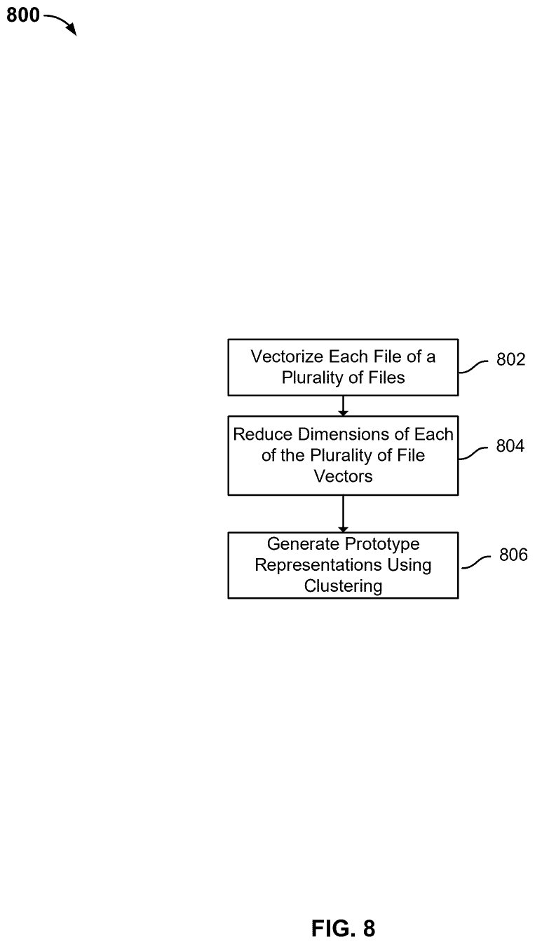

FIG. 8 is a flow diagram for generating prototype representations in accordance with some embodiments. Process 800 may be executed by a training framework such as training framework 204. The generated prototype representations may be used as training and/or inference data for an ML model in order to determine a file type.

At 802, each file of a plurality of files is vectorized. The plurality of files may include files which comprise all different interpretive languages. Examples of interpretive languages include JavaScript™ (JS), Python™, Powershell™, Shell, Bash, XML, HTML, PERL™, VBS, ASPX, ASP, Batch, JSON, etc. Any vectorization technique may be used. A vectorization technique includes transforming the characters in a file into numerical representations. Examples of vectorization techniques include TF-IDF, Bag of Words (BoW), Word2Vec, Doc2Vec, FastText, GloVe, Count Vectorizer, etc. TF-IDF is a vectorization technique that can transform character sequences into vectors. The result is a numerical vector for each of the plurality of files where each dimension represents a character sequence in the corpus, and the value corresponds to the TF-IDF score.

At 804, the dimension of each of the plurality of file vectors is reduced. This may be done using any dimension reducing method for a vector. Examples include UMAP, Principal Component Analysis (PCA), t-Distributed Stochastic Neighbor Embedding (t-SNE), Singular Value Decomposition (SVD), Autoencoders, Feature selection, Random Projection, Linear Discriminant Analysis (LDA), Isomap, etc.

At 806, prototype representations are generated using clustering. This may include generating a prototype embedding space. In some embodiments, one or more prototype embedding spaces are generated for one or more file types. Any clustering algorithm may be used to generate representative prototype clusters. Examples include HDBSCAN, K-means, hierarchical clustering, DBSCAN, mean shift, gaussian mixture models (GMM), spectral clustering, etc.

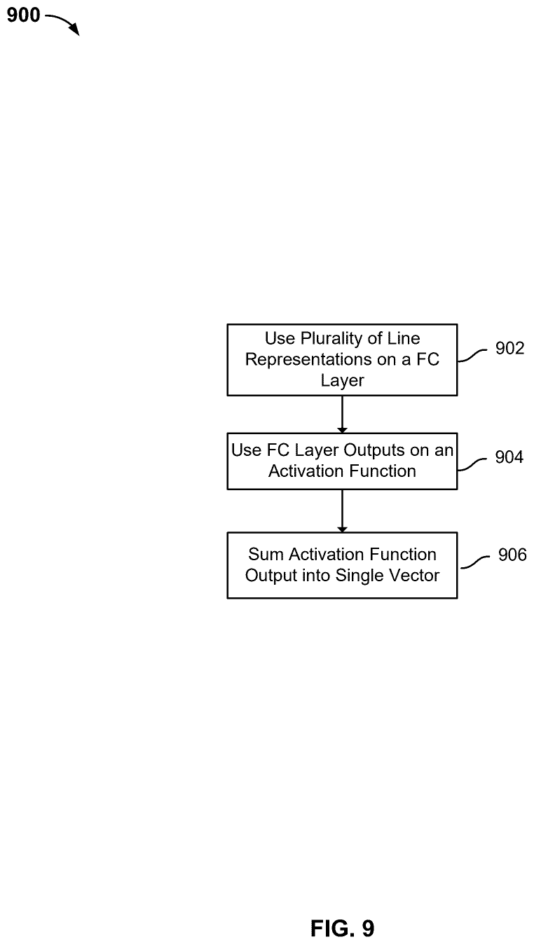

FIG. 9 is a flow diagram for a process which generates a single vector using a simple-attention fuse model in accordance with some embodiments. Process 900 may be executed by an ML model. In some embodiments, the results of process 900 are passed through a KAN layer to generate a representation of the file which corresponds to the line representations.

At 902, a plurality of line representations are used on a fully connected (FC) layer. Line representations are numerical representations of lines of characters that are within the same file. In some embodiments, line representations have been processed by one or more other ML layers. Line representations may be weighted line representations. The FC layer is any type of ML layer where every neuron in the layer is connected to every output of the previous layer. In some embodiments, the FC layer comprises a single neuron, where each line representation is used on the single neuron. The FC layer may comprise a scaler that is multiplied by each number in a vector of each line representation. A sum is taken of the multiplied numbers in a vector of each line representation. The output of the FC layer comprises the sum of the multiplied numbers in a vector of each line representation.

At 904, the FC layer outputs are used on an activation function. Examples of activation functions include Sigmoid, Softmax, ReLu, Tanh, etc. The activation function runs the outputs from the FC layer through an activation function and generates a score for each line. These scores are then used to apply a weight to the corresponding line representation. This generates weighted line representations which correspond to the line representations of 902.

At 906, the outputs of the activation function are summed into a single vector. The single vector may be generated by summing each feature dimension through the weighted line representations.

FIGS. 10A-B are examples of how a training file may be augmented in accordance with some embodiments. After being augmented, the training files may be used on a training framework, such as training framework 204. In FIGS. 10A-B, the language in the files is HTML, however, these augmentations may be done in a similar manner for any language.

In FIG. 10A, file 1002 is augmented into augmented file 1004. In this example, the multiple lines in file 1002 are condensed into a single line in augmented file 1004. This is done to stimulate real world files that comprise a single line.

In FIG. 10B, file 1006 is augmented into augmented file 1008. In this example, multiple comments are introduced to file 1006 in order to produce augmented file 1008.

Augmented files 1004 and 1008 may be used as training data to ensure that the ML model being trained is capable of identifying the file types of files with these structures.

Files 1002 and 1004 are also examples of training files. Files 1002 and 1004 are also examples of files that may be the inputs of a security system which determines the file type. This may be done using any of the methods described herein.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
preprocess a file to generate line representations of a sampled subset of the file;
process the line representations of the sampled subset of the file using a machine learning (ML) model to generate a weighted line representation for each of the generated line representations of the sampled subset of the file;
compress the weighted line representations using a layer of the ML model; and
determine a file type of the file using a classification model on the compressed weighted line representations; and
a memory communication interface coupled to the processor and configured to provide the processor with instructions.

2. The system of claim 1, wherein the file type includes a script file type.

3. The system of claim 1, wherein the processor is further configured to:
generate a security verdict by processing the file using a security pipeline, wherein the security verdict is malicious or benign; and
in response to a determination that the file is malicious, perform an action.

4. The system of claim 1, wherein generating a line representation of the sampled subset of the file further comprises extracting a plurality of bytes from one or more lines of the file.

5. The system of claim 1, wherein the ML model includes a Convolutional Neural Network (CNN) model.

6. The system of claim 1, wherein the ML model further comprises:
a convolutional layer;
a global max layer;
a self-attention layer; and
a simple-attention fuse model.

7. The system of claim 1, wherein the layer of the ML model used for compressing the weighted line representations is a Kolmogorov-Arnold Network (KAN) layer.

8. The system of claim 1, wherein the processor is further configured to create a prototype embedding space by performing the following:
vectorize each file of a plurality of files to generate a plurality of file vectors;
reduce dimensions of each of the plurality of file vectors; and
generate prototype representations using clustering.

9. The system of claim 8, wherein determining the file type using the classification model on the compressed weighted line representations further comprises determining a minimum distance between an output from the ML model and the prototype representations.

10. The system of claim 8, wherein vectorizing each file of the plurality of files is performed using Term Frequency-Inverse Document Frequency (TF-IDF).

11. The system of claim 1, wherein the processor is further configured to augment one or more training files for training the ML model.

12. A method, comprising:
preprocessing a file to generate line representations of a sampled subset of the file;
processing the line representations of the sampled subset of the file using a machine learning (ML) model to generate a weighted line representation for each of the generated line representations of the sampled subset of the file;
compressing the weighted line representations using a layer of the ML model; and
determining a file type of the file using a classification model on the compressed weighted line representations.

13. The method of claim 12, wherein the file type includes a script file type.

14. The method of claim 12, further comprising
generating a security verdict by processing the file using a security pipeline, wherein the security verdict is malicious or benign; and
in response to a determination that the file is malicious, performing an action.

15. The method of claim 12, wherein generating a line representation of the sampled subset of the file further comprises extracting a plurality of bytes from one or more lines of the file.

16. The method of claim 12, wherein the ML model includes a Convolutional Neural Network (CNN) model.

17. The method of claim 12, wherein the layer of the ML model used for compressing the weighted line representations is a Kolmogorov-Arnold Network (KAN) layer.

18. The method of claim 12, wherein the ML model further comprises:
a convolutional layer;
a global max layer;
a self-attention layer; and
a simple-attention fuse model.

19. The method of claim 12, further comprising augmenting one or more training files for training the ML model.

20. A computer program product embodied in a non-transitory computer readable medium and comprising computer instructions for:
preprocessing a file to generate line representations of a sampled subset of the file;
processing the line representations of the sampled subset of the file using a machine learning (ML) model to generate a weighted line representation for each of the generated line representations of the sampled subset of the file;
compressing the weighted line representations using a layer of the ML model; and
determining a file type of the file using a classification model on the compressed weighted line representations.
